(19) United States
(12) Patent Application Publication
(10) Pub. No.: US 2014/0032402 A1
(43) Pub. Date: Jan. 30, 2014

(54) SYSTEMS, METHODS AND COMPUTER PROGRAM PRODUCTS THAT FACILITATE SATISFACTION OF FINANCIAL OBLIGATIONS

(71) Applicants: Neal Harris Stern, Virginia Beach, VA (US); Peter Kent McCammon, Virginia Beach, VA (US); Elizabeth Wells Shumadine, Norfolk, VA (US); Francesco Domenico Mancia, Cool, CA (US); Glen Alyn Everroad, Laguna Beach, CA (US)

(72) Inventors: Neal Harris Stern, Virginia Beach, VA (US); Peter Kent McCammon, Virginia Beach, VA (US); Elizabeth Wells Shumadine, Norfolk, VA (US); Francesco Domenico Mancia, Cool, CA (US); Glen Alyn Everroad, Laguna Beach, CA (US)

(21) Appl. No.: 13/557,999

(22) Filed: Jul. 25, 2012

(51) Int. Cl. G06Q 20/14

(52) U.S. Cl. 705/40

(57) ABSTRACT

Financial obligation satisfaction methods, systems and computer program products aggregate data from a plurality of third parties regarding financial obligations of a plurality of persons, monitor the data to determine if a person has exceeded a threshold number of financial obligations and/or a threshold financial obligation amount, and initiate a financial obligations satisfaction process in response to determining that the person has exceeded a threshold number of financial obligations and/or a threshold financial obligation amount. Initiating a financial obligation satisfaction process may include distraining property of the person and may include providing information about how to satisfy the one or more financial obligations.

### FIELD OF THE INVENTION

The present invention relates generally to financial data and, more particularly, to financial obligation data.

### BACKGROUND

Vehicle parking laws are typically enforced by issuing a summons and placing the summons on a vehicle in violation. Typically, the vehicle owner is required to pay the fine or appear in court to contest the summons. Unfortunately, in many areas, some vehicle owners do not promptly pay fines that are due and allow summons and fines to accumulate. One solution to insure payment of such fines is to place an immobilizing device, often referred to as a clamp or “boot”, on the wheel of a vehicle currently in violation and/or on the wheel of a vehicle of a scofflaw with unpaid parking summons.

The use of immobilizing devices has become popular with law enforcement, parking attendants, municipal governments, and the like, in the enforcement of parking and other violations. In use, an installer places an immobilizing device on a vehicle wheel, thereby immobilizing the vehicle. Upon returning to the vehicle, the offender is prompted by a notice placed on the vehicle (e.g., a sticker on the window, notice under a windshield wiper, etc.) to call the appropriate entity, e.g., the police, parking authority, or other third party, in order to learn how to have the immobilizing device removed. The offender is prompted during the call to make his/her way to the police station, parking authority, or other third party location in order to pay the fine for a current violation and any other outstanding fines. Once the offender has paid all outstanding amounts, the appropriate entity typically sends someone to remove the immobilizing device from the vehicle.

“Scofflaw” is the term commonly used for a person who habitually flouts or violates the law by not paying fines and other financial obligations, not answering summonses, etc. Scofflaws flout parking regulations by discarding or otherwise ignoring parking citations they receive. In some cases, scofflaws accumulate parking citations in multiple jurisdictions. Unfortunately, the identification of a vehicle with an outstanding citation in the jurisdiction where the vehicle is currently located may not lead to the recognition that there are other outstanding citations in other jurisdictions. In addition, it is currently difficult to determine if a person owes fines and other financial obligations in multiple jurisdictions.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments of the present invention, a financial obligation satisfaction method includes aggregating data from a plurality of third parties regarding financial obligations of a plurality of persons, monitoring the data to determine if a person has exceeded a threshold number of financial obligations and/or a threshold financial obligation amount, and initiating a financial obligations satisfaction process in response to determining that the person has exceeded a threshold number of financial obligations and/or a threshold financial obligation amount. The third parties may be located in one or more legal jurisdictions. Initiating a financial obligation satisfaction process may include distraining property of the person. For example, a vehicle owned by or associated with the person can be identified, located, and then distrained (e.g., impounded, immobilized, etc.).

In some embodiments of the present invention, initiating a financial obligation satisfaction process may include providing information to a person about one or more financial obligations of the person, including information about how to pay the one or more financial obligations. The financial obligation information may be provided via a display device in communication with at least one processor, and may include a listing of the one or more financial obligations owed by the person. In addition, information regarding how to pay the one or more financial obligations may be displayed via the display device.

In some embodiments of the present invention, the one or more financial obligations in the listing are selectable, and information regarding how to pay a financial obligation is displayed in response to selection of the respective financial obligation. Displaying information regarding how to pay the one or more financial obligations in the listing may include displaying one or more financial payment options that can be utilized to pay the one or more financial obligations via the data processing system. The at least one processor may be configured to process financial payments via one of the one or more financial payment options. The at least one processor may be configured to provide access to a remote entity that can process an online payment of the one or more financial obligations.

According to other embodiments of the present invention, a method of facilitating payment of outstanding financial obligations includes receiving, via a data processing system, an identification of property distrained (e.g., a vehicle) as a result of one or more financial obligations of a person associated with the property, and displaying, via a display device in communication with the data processing system, a listing of the one or more financial obligations of the person in response to receiving the property identification. The one or more financial obligations may be owed to one or more third parties in one or more legal jurisdictions.

Information regarding how to pay the one or more financial obligations may be displayed via the display device. The one or more financial obligations in the listing may be selectable by a user, and the information regarding how to pay a financial obligations is displayed in response to selection of the respective financial obligations.

In some embodiments of the present invention, the listing of one or more financial obligations may be updated in real time, or substantially real time, to reflect satisfaction of any of the one or more financial obligations.

In some embodiments of the present invention, displaying information regarding how to satisfy the one or more financial obligations in the listing includes displaying one or more financial payment options that can be utilized to pay the one or more financial obligations via the data processing system. The data processing system may be configured to process a financial payment via one of the one or more financial payment options. The data processing system may be configured to provide access to a remote entity that can process an online payment of the one or more financial obligations.

According to some embodiments of the present invention, a method of releasing property from distrainment, wherein an owner of the property has one or more outstanding financial obligations, includes entering an identification of the property via a first user interface in communication with a data processing system, and verifying, via a second user interface displayed by the data processing system in response to entering the property identification, that the one or more financial obligations have been satisfied, and releasing the property from distrainment. Releasing the property from distrainment may include releasing the property from impoundment. If the distrained property is a vehicle, releasing the vehicle from distrainment may include releasing the vehicle from impoundment, removing an immobilizing device from the vehicle, or providing a person with instructions for use in removing an immobilizing device from the vehicle.

According to other embodiments of the present invention, a method of distraining a vehicle includes obtaining identification information for a vehicle (e.g., license plate information, vehicle identification number, etc.), determining if an owner of the vehicle has exceeded a threshold number of financial obligations and/or a threshold financial obligation amount to one or more third parties in one or more legal jurisdictions, and immobilizing the vehicle in response to determining that the threshold number of financial obligations and/or threshold financial obligation amount has been exceeded. In addition, information may be to the vehicle owner about each financial obligation, including information about how to satisfy each financial obligation.

According to some embodiments of the present invention, a system that facilitates satisfaction of financial obligations includes at least one processor that is configured to aggregate data from a plurality of third parties (e.g., third parties in one or more legal jurisdictions) regarding financial obligations of a plurality of persons, monitor the data to determine if a person has exceeded a threshold number of financial obligations and/or a threshold financial obligation amount, and initiate a financial obligation satisfaction process in response to determining that the person has exceeded a threshold number of financial obligations and/or a threshold financial obligation amount. The at least one processor is also configured to identify a vehicle associated with the person and initiate distrainment of the vehicle. The at least one processor may also be configured to display, via a display device, a listing of one or more financial obligations of the person, and may also display information regarding how to satisfy the one or more financial obligations.

According to some embodiments of the present invention, a system that facilitates satisfaction of financial obligations includes at least one processor configured to receive an identification of property distrained (e.g., a vehicle, etc.) as a result of one or more financial obligations of a person associated with the property, and display, via a display device, a listing of the one or more financial obligations of the person in response to receiving the property identification, wherein the one or more financial obligations are owed to one or more third parties in one or more legal jurisdictions. The at least one processor may also display, via the display device, information regarding how to satisfy the one or more financial obligations.

In some embodiments of the present invention, the one or more financial obligations displayed in a listing on a device are selectable, and the at least one processor is configured to display information regarding how to satisfy a financial obligation in response to selection of the respective financial obligation. In some embodiments of the present invention, the at least one processor is configured to display one or more financial payment options that can be utilized to pay the one or more financial obligations. The at least one processor may be configured to process a financial payment via one of the one or more financial payment options. The at least one processor may be configured to provide access to a remote entity that can process an online payment of the one or more financial obligations.

According to some embodiments of the present invention, a system that facilitates vehicle distrainment includes at least one processor that is configured to receive identification information for a vehicle (e.g., license plate information, vehicle identification number, etc.), and determine if an owner of the vehicle has exceeded a threshold number of financial obligations and/or a threshold financial obligation amount to one or more third parties in one or more legal jurisdictions. In addition, the at least one processor may be configured to provide information to the vehicle owner about each financial obligation, and display one or more financial payment options that can be utilized by the vehicle owner to pay each financial obligation.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1 is a block diagram that illustrates systems, methods, and computer program products, according to some embodiments of the present invention, that facilitate aggregation of data from a plurality of third parties regarding financial obligations of a plurality of persons, and that facilitate satisfaction of financial obligations.

FIGS. 2-5 are flow charts of operations for aggregating financial obligation information from a plurality of third parties, monitoring the aggregated information to determine if a person has exceeded a threshold number of financial obligations and/or a threshold financial obligation amount, and initiating a financial obligation satisfaction process, according to some embodiments of the present invention.

FIG. 6 is a flow chart of operations for facilitating the satisfaction of financial obligations, according to some embodiments of the present invention.

FIG. 7 is a flow chart of operations for releasing property from distrainment, according to some embodiments of the present invention.

FIG. 8 is a flow chart of operations for facilitating the satisfaction of financial obligations, according to some embodiments of the present invention.

FIG. 9 is a block diagram that illustrates details of an exemplary processor and memory that may be used to implement various functions of a financial obligation satisfaction data processing system, according to some embodiments of the present invention.

FIG. 10 illustrates an exemplary user interface having a listing of financial obligations of a person, according to some embodiments of the present invention.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain components or features may be exaggerated for clarity. In addition, the sequence of operations (or steps) is not limited to the order presented in the claims unless specifically indicated otherwise. Although described or shown with respect to one embodiment and/or figure, the features and elements so described or shown can apply to other embodiments and/or figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

It will be understood that although the terms first and second are used herein to describe various features or elements, these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well- known functions or constructions may not be described in detail for brevity and/or clarity.

The terms “data processing system”, “processor”, and “at least one processor”, as used herein, are interchangeable.

The term “distrain”, as used herein, means to seize and hold property and/or goods for the purpose of obtaining satisfaction of one or more financial obligations.

The term “financial obligation”, as used herein, refers to any financial amount owed to another person/entity including, but not limited to, taxes, fees, assessments, fines, penalties, court-designated payments, and the like. A non-exhaustive list of exemplary financial obligations payable to a municipality or other legal jurisdiction includes, but is not limited to, franchise fees, campaign/election fees, lobbyist registration fees, passport services fees, special events fees, filming fees, block party/street closure fees, carnival fees, location fees, court fees, environmental fees, zoning fees, development fees, sign fees, site plan review fees, approval fees, planning fees, subdivision application fees, zoning amendment fees, general plan amendment fees, appeal fees, certificate of appropriateness fees, building fees, permit fees, inspection fees, code enforcement fees, business license and permit fees, parking fees, late fees, false alarm fees, utility fees, purchasing fees, medical transport fees, vehicle towing and impoundment fees, housing fees, sanitation fees, water fees, medical waste fees, manufacturing fees, emergency response fees, library fees, commercial use fees, engineering fees, parks and recreation fees, animal fees, law enforcement fees, business tax, property tax, sales/use tax, occupancy tax, admissions tax, parking tax, utility user tax, and the like.

The term “legal jurisdiction”, as used herein, means all types of geographically-delineated areas of authority including, but not limited to, countries, states, counties, and municipalities. The terms “legal jurisdiction” and “jurisdiction”, as used herein, are interchangeable.

The term “municipality”, as used herein, includes cities, towns, villages, etc.

The term “real time”, as used herein, refers to a level of computer (e.g., data processing system, processor, etc.) responsiveness that a user senses as sufficiently immediate or that enables the computer to keep up with some external process. Thus, in the context of embodiments of the present invention, changes in the status of financial obligations (e.g., because of satisfaction, etc.) may be displayed substantially as changes occur.

Exemplary embodiments of the present invention may be embodied as methods, systems, and/or computer program products. Accordingly, exemplary embodiments of the present invention may be embodied in hardware and/or in software (including firmware, resident software, micro-code, etc.). Furthermore, exemplary embodiments of the present invention may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Some aspects of the present invention may be implemented in a “cloud” computing environment. Cloud computing is a computing paradigm where shared resources, such as processor(s), software, and information, are provided to computers and other devices on demand typically over a network, such as the Internet. In a cloud computing environment, details of the computing infrastructure, e.g., processing power, data storage, bandwidth, and/or other resources are abstracted from the user. The user does not need to have any expertise in or control over such computing infrastructure resources. Cloud computing typically involves the provision of dynamically scalable and/or virtualized resources over the Internet. A user may access and use such resources through the use of a Web browser. A typical cloud computing provider may provide an online application that can be accessed over the Internet using a browser. The cloud computing provider, however, maintains the software for the application and some or all of the data associated with the application on servers in the cloud, i.e., servers that are maintained by the cloud computing provider rather than the users of the application.

Exemplary embodiments of the present invention are described herein with reference to flowchart and/or block diagram illustrations. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer- readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

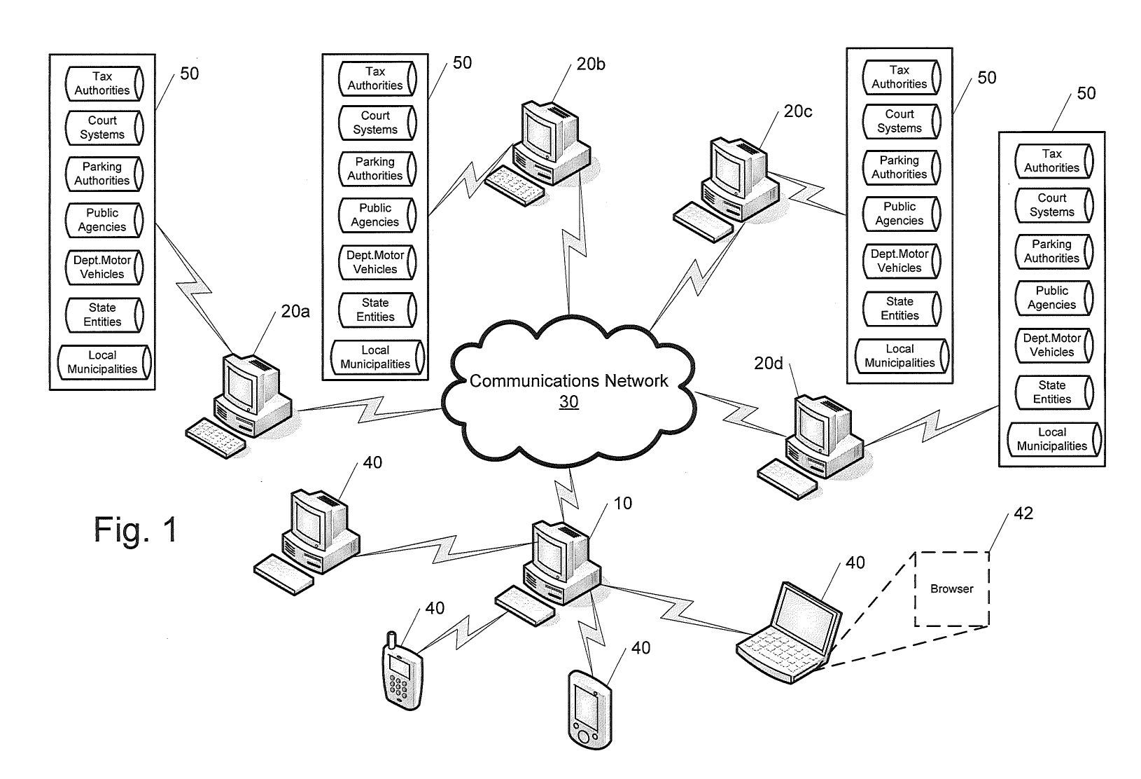

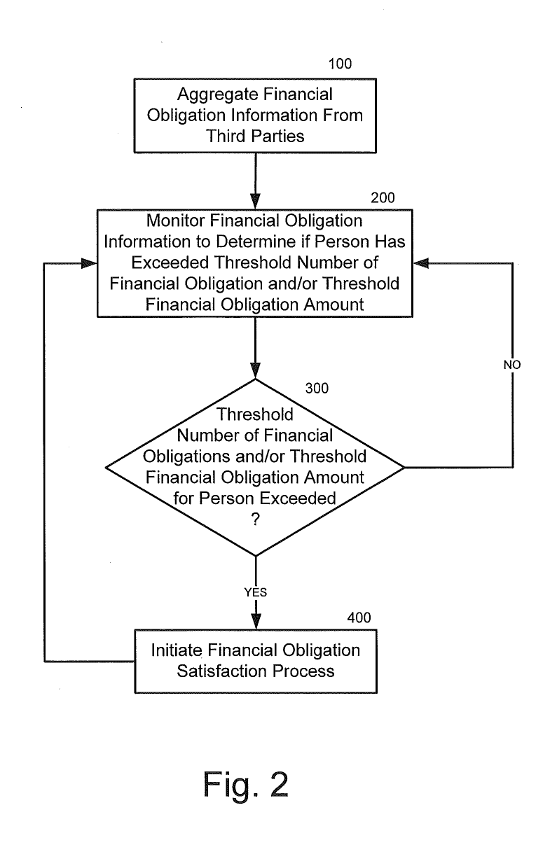

Referring now to the figures, various methods, systems and computer program products that facilitate satisfaction of financial obligations will be described. Referring initially to FIGS. 1 and 2, a data processing system 10 (FIG. 1), aggregates (i.e., collects) data from a plurality of third parties (Block 100, FIG. 2), via data processing systems 20a-20d (FIG. 1), regarding financial obligations of a plurality of persons and/or entities. Each illustrated data processing system 20a-20d is associated with a source of financial obligation information and/or has access to financial obligation information of a third party (i.e., tax, authority, court system, parking authority, public agency, department of motor vehicles, etc.). In FIG. 1, 50 collectively refers to any source of financial obligation information that can be aggregated by data processing system 10.

For example, as illustrated in FIG. 1, data processing system 10 can aggregate financial obligation information from one or more tax authorities in one or more legal jurisdictions, one or more court systems in one or more legal jurisdictions, one or more parking authorities in one or more legal jurisdictions, one or more public agencies in one or more legal jurisdictions, one or more department of motor vehicles within one or more legal jurisdictions, etc., via data processing systems 20a-20d.

The data processing system 10 communicates with the plurality of third party data processing systems 20a-20d via a communications network 30, such as the Internet. Although the data processing system 10 is only illustrated communicating with four other third party data processing systems 20a-20d, it is understood that the data processing system 10 may communicate and aggregate data from any number of third party data processing systems, without limitation. Although FIG. 1 illustrates an exemplary communication network and an exemplary hardware/software architecture that may be used, it will be understood that embodiments of the present invention are not limited to such a configuration but are intended to encompass any configuration capable of aggregating data and carrying out operations described herein. For example, data processing system 10 may include one or more processors in on or more locations. Similarly, data processing systems 20a-20d may include one or more processors in on or more locations.

Data processing system 10 may communicate with various third party data processing systems in various ways, without limitation. For example, data processing system 10 can communicate with a third party data processing system via a communication network (e.g., via the internet, an intranet, etc.), via a direct link, via a File-Transfer-Protocol (FTP) link, via a wireless connection, etc. Data processing system 10 can collect data from third party data processing systems in various formats, without limitation (e.g., data from spreadsheets, data from databases, data from text files, data from flat files, etc.).

Exemplary third party data processing systems represented by 20a-20d may include, but are not limited to, data processing systems of or in communication with various entities within a legal jurisdiction including, but not limited to, tax authorities, court systems, parking authorities, department of motor vehicles, public agencies, etc. Data processing systems represented by 20a-20d may contain and/or have access to data regarding unpaid parking violations, unpaid alimony, unpaid child support, unpaid taxes, etc.

In some embodiments of the present invention, aggregating data processing system 10 may be the data processing system of a municipality, tax authority, court system, parking authority, department of motor vehicles, public agency, etc., or may be the data processing system of an independent contractor associated with a municipality, tax authority, court system, parking authority, department of motor vehicles, public agency, etc. Third party data systems 20a-20d may include all types of data processing systems, without limitation, including, but not limited to, mainframe computing systems, mini- computer systems, individual computing devices (e.g., desktop computers, workstations, etc.), and the like. Similarly, the aggregating data processing system 10 may include all types of data processing systems, without limitation, including, but not limited to, mainframe computing systems, mini-computer systems, individual computing devices (e.g., desktop computers, workstations, etc.), and the like.

The third party data processing systems 20a-20d may be located in one or more legal jurisdictions on the federal level, state level, and/or municipal level, etc., without limitation. For example, third party data processing system 20a may be located in California, third party data processing system 20b may be located in Nevada, third party data processing system 20c may be located in Texas, and third party data processing system 20d may be located in New York. In another example, the various third party data processing systems 20a-20d may be located in different cities or municipalities within the same state, e.g., third party data processing system 20a may be located in Los Angeles, third party data processing system 20b may be located in San Diego, third party data processing system 20c may be located in San Francisco, and third party data processing system 20d may be located in Sacramento. Various combinations of legal jurisdictions are possible without limitation.

The data processing system 10 may aggregate data on a continuous basis or periodic basis. For example, the data processing system 10 may communicate with third party data processing systems daily, weekly, monthly, or some combination thereof, to collect data. In some embodiments of the present invention, data may be collected from one or more third party data processing systems continuously (e.g., in real time or substantially real time).

In some embodiments of the present invention, data from one or more third parties may be collected manually from one or more third parties. For example, one or more persons may periodically visit various third parties having financial obligation data, obtain the data, and then have the data entered into the data processing system 10. In some embodiments of the present invention, data from one or more third parties may be collected from one or more third parties via mail, fax, and/or email and then input into the data processing system 10.

The data processing system 10 monitors the collected data to determine if a person has exceeded a threshold number of financial obligations and/or a threshold financial obligation amount owed (Block 200). If a threshold number of financial obligations and/or a threshold financial obligation amount has been exceeded by a person (Block 300), a financial obligation satisfaction process is initiated for the person (Block 400). The financial obligation satisfaction process may be initiated by the data processing system 10 by notifying a person/entity authorized to initiate such a process.

For example, certain legal jurisdictions permit financial obligation satisfaction efforts to be initiated if a person exceeds a certain number of financial obligations (e.g., two or more unpaid parking violations, two or more unpaid red-light ticket camera violations, two or more months of unpaid child support, etc.) within a jurisdiction. In addition, intra-jurisdictional agreements may allow financial obligation satisfaction efforts to be initiated if a person exceeds a certain number of financial obligations in multiple legal jurisdictions. For example, some intra-jurisdictional agreements permit distrainment of property owned by a person that is not directly associated with a particular financial obligation or that is not directly associated with a financial obligation in a particular jurisdiction. As an example, assume a person owns two vehicles and the vehicles are registered in New York. The person has accumulated a number of unpaid parking violations on one of the vehicles. Because of an intra- jurisdictional agreement between New York and New Jersey, a parking authority can initiate a financial obligation satisfaction process on the person by distraining the second vehicle when located in New Jersey as a result of the unpaid parking violations on the person's other car.

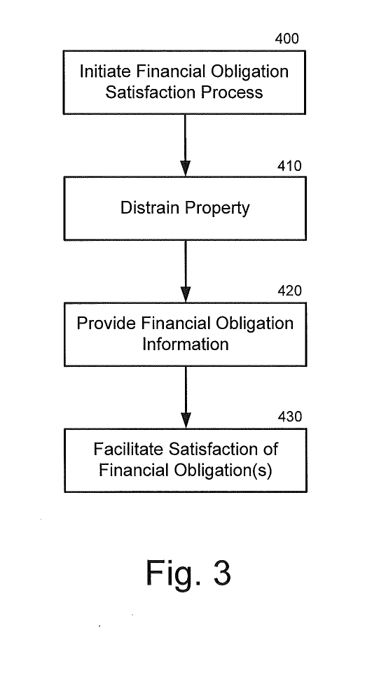

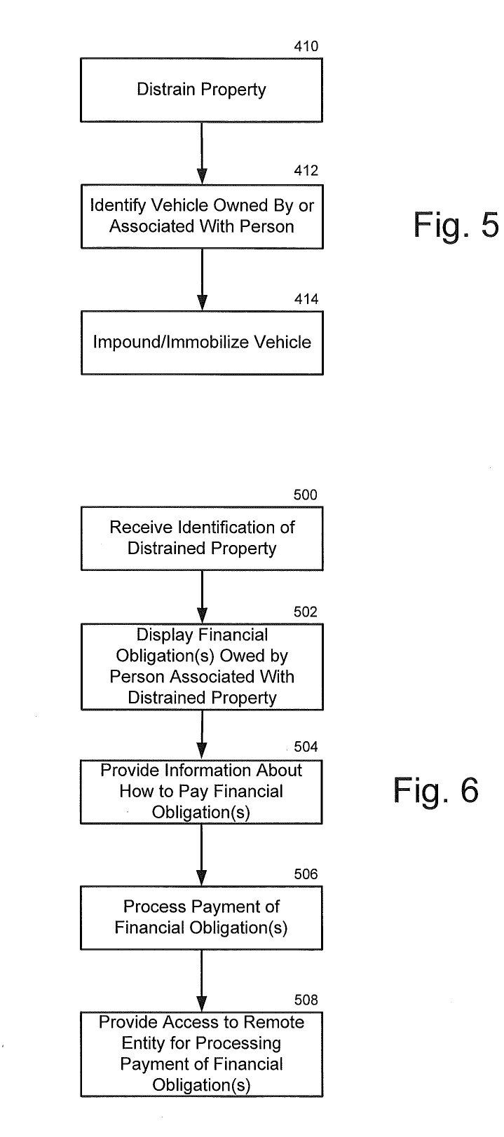

Referring now to FIG. 3, one method of initiating a financial obligation satisfaction process (Block 400), according to some embodiments of the present invention, includes initiating the distrainment of property owned or associated with a person (Block 410), providing financial obligation information to the person (Block 420) and facilitating satisfaction of the financial obligation by the person (Block 430). Vehicle distrainment is a popular procedure for enforcing the satisfaction of financial obligations. For example, a vehicle owned by or associated with a person having unpaid financial obligations can be identified (Block 412, FIG. 5) and then impounded/immobilized (Block 414). Vehicle identification can be achieved in various ways. One way is via the use of license plate recognition (LPR) technology which utilizes optical character recognition technology on images taken by cameras to read vehicle license plates. Other methods of vehicle identification may be utilized as well, without limitation.

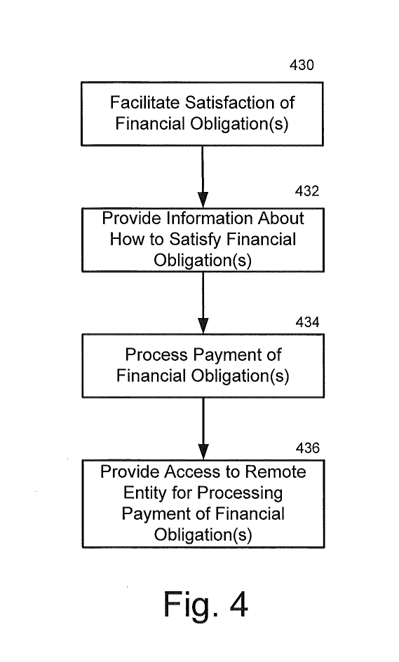

Referring to FIG. 4, operations for facilitating satisfaction of financial obligations (Block 430) are illustrated. Once a person's property, such as a vehicle, has been distrained, the person is provided information about outstanding financial obligations owed by the person, and may also be provided with information about how to satisfy the one or more financial obligations (Block 432). For example, a person can communicate with the data processing system 10 (FIG. 1), for example, via a web browser 42 (FIG. 1) executing on a device 40 (FIG. 1) and view a listing of financial obligations of the person. Exemplary devices 40 include personal computers, laptop computers, smart phones, PDAs, and the like. Additional information provided may include past payment information including, but not limited to, past payment status, dates and times of past payments. Moreover, embodiments of the present invention may be configured to provide updates on the payment status of various financial obligations.

In addition to providing information about how to satisfy financial obligations, the data processing system 10 (FIG. 1) may be configured to process payment of financial obligations (Block 434) and/or provide access to one or more remote entities for processing payment of financial obligations (Block 436).

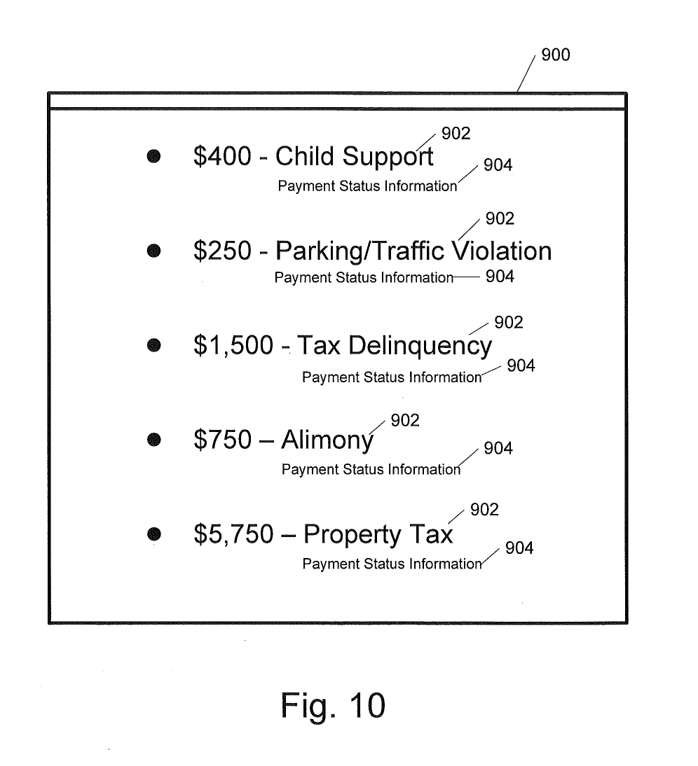

FIG. 10 illustrates an exemplary user interface 900 having a listing of various financial obligations 902 of a person. Each financial obligation 902 in the illustrated user interface 900 is user-selectable. Upon selection by a user, for example, via a mouse click, stylus, or keypad entry, information regarding how to pay the financial obligation (e.g., one or more financial payment options that can be utilized to pay the financial obligation) is displayed in response to selection of the respective financial obligation 902. In some embodiments of the present invention, the data processing system 10 can be utilized to process financial payment of financial obligations of the person, for example, via a credit card, Pay-Pal, bank draft, etc. In other embodiments of the present invention, the data processing system 10 can provide access to a remote entity (e.g., a third party data processing system) that can process an online payment of financial obligations of the person. For example, if a person owes a financial obligation to a parking authority, in some embodiments the data processing system 10 can provide the person with access to a data processing system of the parking authority that can process payments.

In some embodiments of the present invention, financial obligation information displayed within a user interface, such as user interface 900, is updated in real time, or substantially real time, to reflect satisfaction of any of the one or more financial obligations 902. A payment status information button 904 may be associated with each displayed financial obligation 902. Upon activation by a user, payment status information button 904 for a particular financial obligation 902, such as dates and times of past payments, dues dates for future payments, etc. may be displayed. Various other information can be displayed, without limitation.

According to some embodiments of the present invention, methods, systems and computer program products are provided that facilitate satisfaction of financial obligations. For example, a data processing system, such as the data processing system 10, can be configured to provide information to persons who have had property (e.g., a vehicle) distrained. As illustrated in FIG. 6, the data processing system 10 receives identification of distrained property (Block 500) via a remote device 40 (e.g., a person, via a device 40 and browser 42, enters a vehicle license plate number). In response to receiving identification of distrained property, the data processing system 10 displays the financial obligation(s) of a person associated with the distrained property (Block 502). As described above, the data processing system 10 can also provide information regarding how to pay the financial obligation(s) (Block 504), can process payment of the financial obligation(s) (Block 506), and/or can provide access to a remote entity for processing payment of the financial obligation(s) (Block 508). The data processing system 10 can also facilitate how to distribute and prioritize payments among multiple financial obligations.

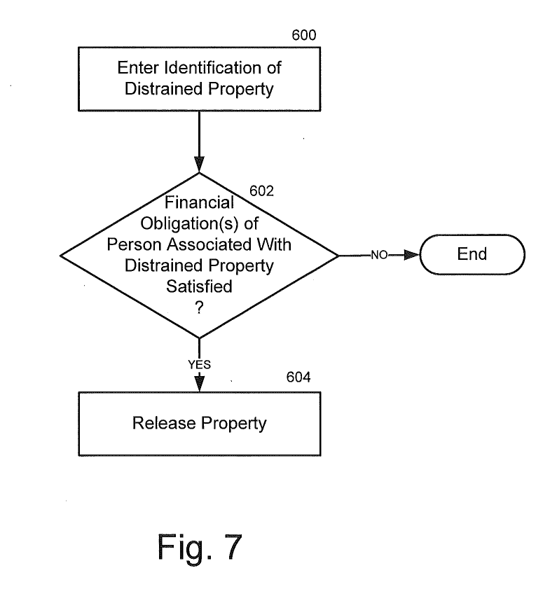

According to some embodiments of the present invention, methods, systems and computer program products are provided that facilitate releasing property from distrainment. A parking authority (or other entity) that immobilizes/impounds vehicles as a result of an unpaid financial obligation may access a data processing system, such as the data processing system 10, to verify that all financial obligations associated with an immobilized/impounded vehicle have been paid prior to authorizing release of the vehicle. For example, as illustrated in FIG. 7, an identification of distrained property is entered by a person associated with the parking authority (or other entity) via a first user interface in communication with a data processing system, such as the data processing system 10 (Block 600). The person verifies, via a second user interface displayed by the data processing system in response to entering the property identification, that the one or more financial obligations have been satisfied (Block 602). For example, the second user interface may include a listing of previous unsatisfied financial obligations and the may display an indication that the financial obligations have been satisfied. In response to verifying that all financial obligations have been satisfied, the property is released from distrainment (Block 604). In some embodiments of the present invention, the data processing system is configured to update the listing of one or more financial obligations in real time to reflect payment of any of the one or more financial obligations.

Releasing the property from distrainment may include releasing the property from impoundment. If the property is a vehicle, releasing the property from distrainment may include releasing the vehicle from impoundment or removing an immobilizing device from the vehicle. In some embodiments of the present invention, releasing a vehicle from distrainment may include providing a person with instructions for use in removing an immobilizing device from the vehicle.

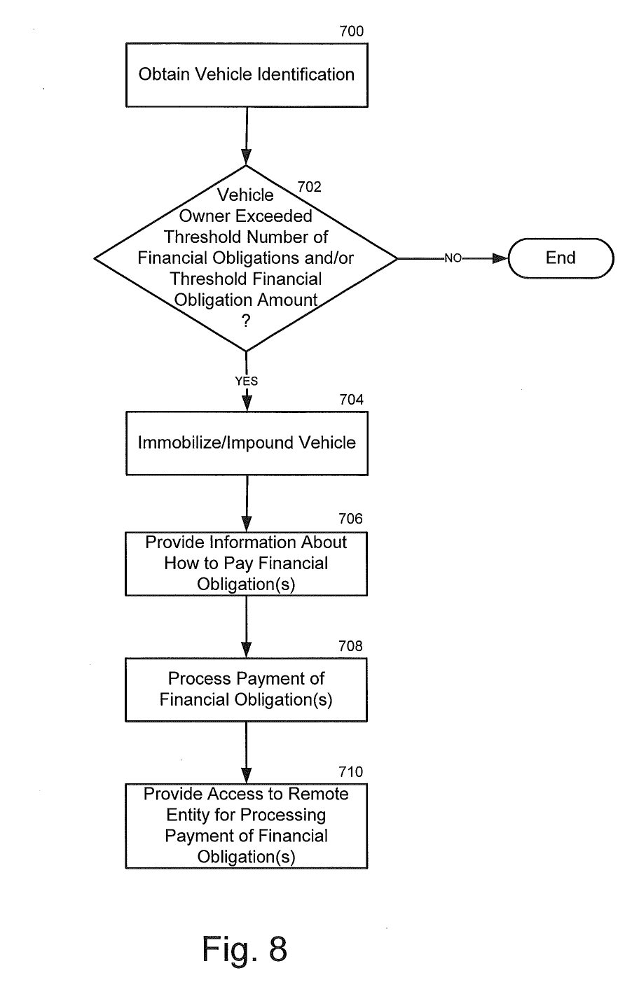

Referring now to FIG. 8, a method of distraining a vehicle, according to some embodiments of the present invention, is illustrated. Identification information (e.g., license plate information) for a vehicle is obtained (Block 700), for example via LPR technology or other means, and entered into a data processing system, such as data processing system 10. The data processing system determines whether an owner of the vehicle has exceeded a threshold number of financial obligations and/or a threshold financial obligation amount to one or more third parties in one or more legal jurisdictions (Block 702). If a threshold number of financial obligations and/or threshold financial obligation amount has been exceeded, the data processing system notifies a person/entity with authorization to immobilize a vehicle and the vehicle is immobilized (Block 704). Immobilization may include placing an immobilizing device on the vehicle and/or impounding the vehicle. The vehicle owner is provided information, for example via the data processing system, about each financial obligation, including information about how to satisfy each financial obligation.

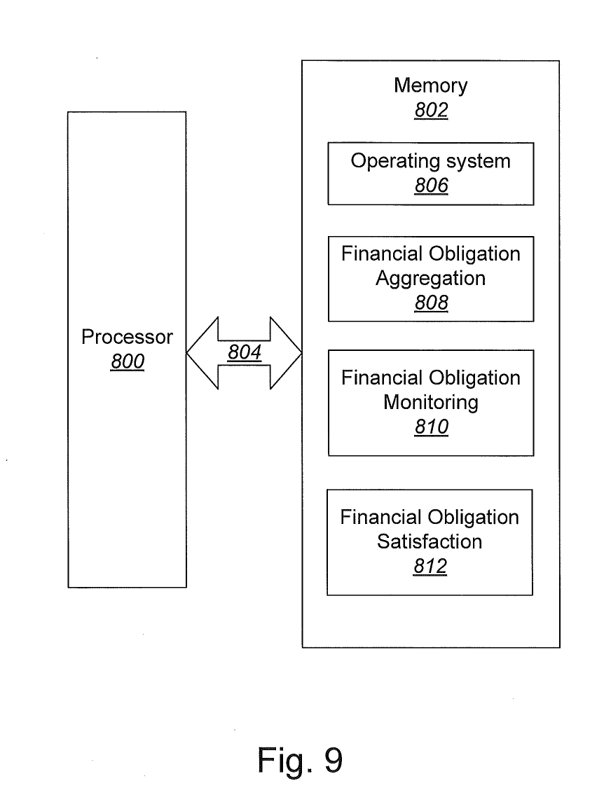

FIG. 9 illustrates an exemplary processor 800 and memory 802 of a data processing system that may be used to implement the functions of data processing system 10 and the various operations of FIGS. 2-8, according to some embodiments of the present invention. The processor 800 communicates with the memory 802 via an address/data bus 804. The processor 800 may be, for example, a commercially available or custom microprocessor. The memory 802 is representative of the overall hierarchy of memory devices containing the software and data used to implement various functions of the data processing system 10 (FIG. 1) as described herein. The memory 802 may include, but is not limited to, the following types of devices: cache, ROM, PROM, EPROM, EEPROM, flash, SRAM, and DRAM.

As shown in FIG. 9, the memory 802 may hold various categories of software and data: an operating system 806, a financial obligation aggregation module 808, a financial obligation monitoring module 810, and a financial obligation satisfaction module 812. The operating system 806 controls operations of one or more data processors that implement the data processing system 10 (FIG. 1). In particular, the operating system 806 may manage the resources of the data processing system 10 and may coordinate execution of various programs (e.g., financial obligation aggregation module 808, financial obligation monitoring module 810, and financial obligation satisfaction module 812, etc.) by the processor 800.

The financial obligation aggregation module 808 comprises logic for aggregating data from a plurality of third parties (e.g., third party data processing systems) regarding financial obligations of a plurality of persons. The financial obligation monitoring module 810 comprises logic for monitoring aggregated financial obligation data to determine if a person has exceeded a threshold number of financial obligations and/or a threshold financial obligation amount. The financial obligation satisfaction module 812 comprises logic for initiating a financial obligation satisfaction process in response to determining that a person has exceeded a threshold number of financial obligations and/or a threshold financial obligation amount. The financial obligation satisfaction module 812 also comprises logic for providing information to a person about one or more financial obligations of the person, including information about how to satisfy the one or more financial obligations. In some embodiments of the present invention, the financial obligation satisfaction module 812 also comprises logic for processing financial payments for satisfying financial obligations and/or comprises logic for providing access to a remote entity that can process payments for satisfying financial obligations. In some embodiments of the present invention, the financial obligation satisfaction module 812 also comprises logic for prioritizing and distributing payments for multiple financial obligations.

Computer program code for carrying out operations of processors 104, 304 and 504 discussed herein may be written in a high-level programming language, such as Python, Java, AJAX (Asynchronous JavaScript), C, and/or C++, for development convenience. In addition, computer program code for carrying out operations of exemplary embodiments of the present invention may also be written in other programming languages, such as, but not limited to, interpreted languages. Some modules may be written in assembly language or even micro-code to enhance performance and/or memory usage. However, embodiments of the present invention are not limited to a particular programming language. It will be further appreciated that the functionality of any or all of the program modules may also be implemented using discrete hardware components, one or more application specific integrated circuits (ASICs), or a programmed digital signal processor or microcontroller.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A financial obligation satisfaction method, comprising:
aggregating data from a plurality of third parties regarding financial obligations of a plurality of persons;
monitoring the data to determine if a person has exceeded a threshold number of financial obligations and/or a threshold financial obligation amount; and
initiating a financial obligation satisfaction process in response to determining that the person has exceeded a threshold number of financial obligations and/or a threshold financial obligation amount,
wherein at least one of aggregating data, monitoring the data and initiating a financial obligation satisfaction process is performed using at least one processor.

2. The method of claim 1, wherein initiating a financial obligation satisfaction process comprises distraining property of the person.

3. The method of claim 1, wherein initiating a financial obligation satisfaction process comprises identifying a vehicle owned by the person and distraining the vehicle.

4. The method of claim 3, wherein distraining the vehicle comprises immobilizing the vehicle or impounding the vehicle.

5. The method of claim 1, wherein initiating a financial obligation satisfaction process comprises providing information to the person about one or more financial obligations of the person, including information about how to satisfy the one or more financial obligations.

6. The method of claim 5, wherein providing information to the person about the one or more financial obligations comprises displaying, via a display device in communication with the at least one processor, a listing of the one or more financial obligations of the person.

7. The method of claim 6, further comprising displaying, via the display device, information regarding how to satisfy the one or more financial obligations.

8. The method of claim 7, wherein the one or more financial obligations in the listing are selectable, and wherein information regarding how to pay a financial obligation is displayed in response to selection of the respective financial obligation.

9. The method of claim 7, wherein displaying information regarding how to satisfy the one or more financial obligations in the listing comprises displaying one or more financial payment options that can be utilized to pay the one or more financial obligations via the at least one processor.

10. The method of claim 9, further comprising processing, via the at least one processor, a financial payment via one of the one or more financial payment options.

11. The method of claim 9, further comprising providing, via the at least one processor, access to a remote entity that can process an online payment of the one or more financial obligations.

12. The method of claim 1, wherein at least one of the third parties is a parking authority.

13. The method of claim 1, wherein the third parties are in different legal jurisdictions.

14. A method of facilitating satisfaction financial obligations, the method comprising:
receiving, via a data processing system, an identification of property distrained as a result of one or more financial obligations of a person associated with the property; and
displaying, via a display device in communication with the data processing system, a listing of the one or more financial obligations of the person in response to receiving the property identification, wherein the one or more financial obligations are owed to one or more third parties in one or more legal jurisdictions.

15. The method of claim 14, further comprising displaying, via the display device, information regarding how to satisfy the one or more financial obligations.

16. The method of claim 15, wherein the one or more financial obligations in the listing are selectable, and wherein information regarding how to satisfy a financial obligation is displayed in response to selection of the respective financial obligation.

17. The method of claim 14, further comprising updating the listing of one or more financial obligations in real time to reflect satisfaction of any of the one or more financial obligations.

18. The method of claim 15, wherein displaying information regarding how to satisfy the one or more financial obligations in the listing comprises displaying one or more financial payment options that can be utilized to pay the one or more financial obligations via the data processing system.

19. The method of claim 18, further comprising processing, via the data processing system, a financial payment via one of the one or more financial payment options.

20. The method of claim 14, further comprising providing, via the data processing system, access to a remote entity that can process an online payment of the one or more financial obligations.

21. The method of claim 14, wherein the distrained property is a vehicle, and wherein the identification of property comprises license plate information for the vehicle.

22. The method of claim 14, wherein the distrained property is a vehicle and wherein the one or more third parties comprise one or more parking authorities in one or more legal jurisdictions.

23. A method of releasing property from distrainment, wherein an owner of the property has one or more outstanding financial obligations, the method comprising:
entering an identification of the property via a first user interface in communication with a data processing system;
verifying, via a second user interface displayed by the data processing system in response to entering the property identification, that the one or more financial obligations have been paid, wherein the second user interface displays an indication that the one or more financial obligations have been paid; and
releasing the property from distrainment.

24. The method of claim 23, wherein releasing the property from distrainment, comprises releasing the property from impoundment.

25. The method of claim 23, wherein the property is a vehicle, and wherein releasing the property from distrainment, comprises removing an immobilizing device from the vehicle.

26. The method of claim 25, wherein releasing the property from distrainment, comprises providing a person with instructions for use in removing the immobilizing device from the vehicle.

27. A method of distraining a vehicle, the method comprising:
obtaining identification information for a vehicle;
determining if an owner of the vehicle has exceeded a threshold number of financial obligations and/or a threshold financial obligation amount to one or more third parties in one or more legal jurisdictions; and
immobilizing the vehicle in response to determining that the threshold number of financial obligations and/or threshold financial obligation amount has been exceeded.

28. The method of claim 27, wherein the vehicle identification information comprises license plate information for the vehicle.

29. The method of claim 27, further comprising providing information to the vehicle owner about each financial obligation, including information about how to satisfy each financial obligation.

30. The method of claim 27, wherein the one or more third parties comprise one or more parking authorities in one or more legal jurisdictions.

31. A system that facilitates satisfaction of financial obligations, the system comprising at least one processor configured to:
aggregate data from a plurality of third parties regarding financial obligations of a plurality of persons;
monitor the data to determine if a person has exceeded a threshold number of financial obligations and/or a threshold financial obligation amount owed; and
initiate a financial obligation satisfaction process in response to determining that the person has exceeded a threshold number of financial obligations and/or a threshold financial obligation amount.

32. The system of claim 31, wherein the at least one processor is configured to identify a vehicle associated with the person and initiate distrainment of the vehicle.

33. The system of claim 31, wherein the at least one processor is configured to display, via a display device in communication with the processor, a listing of one or more financial obligations of the person.

34. The system of claim 33, wherein the at least one processor is configured to display, via the display device, information regarding how to satisfy the one or more financial obligations.

35. The system of claim 31, wherein at least one of the third parties is a parking authority.

36. The system of claim 31, wherein the third parties are in different legal jurisdictions.

37. A system that facilitates satisfaction of outstanding financial obligations, the system comprising at least one processor configured to:
receive an identification of property distrained as a result of one or more financial obligations of a person associated with the property; and
display, via a display device, a listing of the one or more financial obligations of the person in response to receiving the property identification, wherein the one or more financial obligations are owed to one or more third parties in one or more legal jurisdictions.

38. The system of claim 37, wherein the at least one processor is configured to display, via the display device, information regarding how to satisfy the one or more financial obligations.

39. The system of claim 38, wherein the one or more financial obligations in the listing are selectable, and wherein the at least one processor is configured to display information regarding how to satisfy a financial obligation in response to selection of the respective financial obligation.

40. The system of claim 38, wherein the at least one processor is configured to display one or more financial payment options that can be utilized to pay the one or more financial obligations.

41. The system of claim 40, wherein the at least one processor is configured to process a financial payment via one of the one or more financial payment options.

42. The system of claim 37, wherein the at least one processor is configured to provide access to a remote entity that can process an online payment of the one or more financial obligations.

43. The system of claim 37, wherein the distrained property is a vehicle and wherein the identification of property comprises license plate information for the vehicle.

44. A system that facilitates vehicle distrainment, the system comprising at least one processor configured to:
receive identification information for a vehicle; and
determine if an owner of the vehicle has exceeded a threshold number of financial obligations and/or a threshold financial obligation amount to one or more third parties in one or more legal jurisdictions.

45. The system of claim 44, wherein the vehicle identification information comprises license plate information for the vehicle.

46. The system of claim 44, wherein the at least one processor is configured to:
provide information to the vehicle owner about each financial obligation; and
display one or more financial payment options that can be utilized by the vehicle owner to pay each financial obligation.

47. A computer program product that facilitates satisfaction of financial obligations, comprising a non-transitory computer readable storage medium having encoded thereon instructions that, when executed on a computer, causes the computer to:
aggregate data from a plurality of third parties regarding financial obligations of a plurality of persons;
monitor the data to determine if a person has exceeded a threshold number of financial obligations and/or a threshold financial obligation amount owed; and
initiate a financial obligation satisfaction process on the person in response to determining that the person has exceeded a threshold number of financial obligations and/or a threshold financial obligation amount.

48. A computer program product that facilitates satisfaction of outstanding financial obligations, comprising a non-transitory computer readable storage medium having encoded thereon instructions that, when executed on a computer, causes the computer to display a listing of one or more financial obligations of a person in response to receiving an identification of distrained property associated with the person, wherein the one or more financial obligations are owed to one or more third parties in one or more legal jurisdictions.

49. The computer program product of claim 48, wherein the computer readable storage medium has encoded thereon instructions that, when executed on a computer, causes the computer to display information regarding how to satisfy the one or more financial obligations.

50. The computer program product of claim 49, wherein the computer readable storage medium has encoded thereon instructions that, when executed on a computer, causes the computer to display one or more financial payment options that can be utilized to pay the one or more financial obligations and to process a financial payment via one of the one or more financial payment options.

51. The computer program product of claim 49, wherein the computer readable storage medium has encoded thereon instructions that, when executed on a computer, causes the computer to provide access to a remote entity that can process an online payment of the one or more financial obligations.

52. A computer program product that facilitates vehicle distrainment, comprising a non-transitory computer readable storage medium having encoded thereon instructions that, when executed on a computer, causes the computer to receive identification information for a vehicle, and determine if an owner of the vehicle has exceeded a threshold number of financial obligations and/or a threshold financial obligation amount owed to one or more third parties in one or more legal jurisdictions.

53. The computer program product of claim 52, wherein the computer readable storage medium has encoded thereon instructions that, when executed on a computer, causes the computer to display information about each financial obligation, including information about how to satisfy each financial obligation.
